(19) United States
(12) Patent Application Publication
(10) Pub. No.: US 2009/0052852 A1
(43) Pub. Date: Feb. 26, 2009

(54) Holey fiber taper with selective transmission for fiber optic sensors and method for manufacturing the same

(76) Inventors: Vladimir Petrovich Minkovich, Leon Guanajuato (MX); Augustin Joel Villa-Toro Bernardo, Torragona (ES); David Monzon Hernandez, Leon Guanajuato (MX)

Correspondence Address: Rosenberg Klein & Lee, 3458 Ellicott Center Drive Suite 101, Ellicott City, MD, 21043, US

(21) Appl. No.: 11/989,289

(22) PCT Filed: Oct. 20, 2006
(86) PCT No.: PCT/MX2006/000114

§ 371 Date: Jan. 24, 2008

(30) Foreign Application Priority Data
Nov. 15, 2005 (MX) GT/S/2005/000015

(51) Int. Cl. G02B 6/02; C03B 7/01

(52) U.S. Cl. 385/125; 65/533

(57) ABSTRACT

Large-mode-area single material holey fiber tapers with collapsed by nonadiabatic process air holes in the waist for fiber optic sensors and a method for manufacturing these tapers are claimed. The gradual collapsing of the holes is achieved by tapering the fibers with a “slow-and-hot” method. This nonadiabatic process makes the fundamental mode of the holey fiber to couple to multiple modes of the solid taper waist. Owing to the beating between the modes, the transmission spectra of the tapered single material holey fibers exhibit several interference peaks. That means the all-fiber Mach-Zehnder type interferometer is formed in a holey fiber such a way. The multiple peaks, combined with a fitting algorithm, allow high-accuracy refractometric measurements, temperature-independent strain measurements, measurements of high temperature and may be used for measuring many others parameters.

### BACKGROUND OF THE INVENTION

The present invention relates to fiber optic devices using microstructured optical fibers, also known as photonic crystal or holey fibers (HFs), which consist of a single material. The HF is a new class of optical fibers with no conventional propagation characteristics that have been largely investigated. Usually HFs consist of a pure silica core surrounded by pure silica cladding with a regular array of air holes that run inside of the cladding along the length of the fiber and are arranged in a hexagonal structure around the core [1,2]. HFs are characterized in terms of hole size and hole spacing. The holes are usually periodically spaced, the period being termed as “pitch”, Λ. The holes are usually circular and can be characterized by a diameter, d.

The structure of single material HFs enables new possibilities for optical sensing and provides an efficient method to exploit the interaction of the guided light with different gases, liquids, or biological samples present inside the holes [3-6]. The advantage of this alternative is that the HF itself can work as a chamber. In addition, some parameters, such as, the size of the holes, the separation of the holes, etc., can be optimized to improve the overlap between the parameter being sensed and the mode field [7, 8]. To use a single material HF as a sensor one has to fill the holes with the sample, a gas or liquid, for example, and then the analysis or detection is carried out. In some situations, such a process may be inconvenient or impractical.

That is why; two new approaches for sensing with a special “grapefruit” microstructured fiber having doped core have been reported recently. One of them consists of adiabatic (“fast-and-cool” method) tapering the fiber, preserving the structure, to a point in which the doped core has sub-wavelength diameter [9]. The other alternative consists of adiabatic tapering the fiber with doped core and collapsing the air holes over a localized region [10, 11]. In both cases the special “grapefruit” microstructured fibers with doped core are used and the tapering process is adiabatic, i.e., the taper does not induce coupling between modes. A fundamental mode propagating through the untapered doped core of the microstructured fiber evolves into a fundamental mode in the taper and in the waist region. The adiabatic tapering process makes the guided mode of the fibers to spread out.

In contrast to the above inventions, the objective of the present invention is a suggestion of a nonadiabatic tapered single material HF structure with gradually collapsed air-holes that causes the transmission spectrum of the taper to exhibit several interference peaks. Shifts of the peaks under the action of different external parameters allow one to use the invention as a sensor for the measurements of many magnitudes for diverse applications.

The manufacturing process, providing the nonadiabatic tapered single material HF structure with collapsed air holes is also different from the known to-date.

### SUMMARY OF THE INVENTION

According to the first aspect of the invention, reflected in FIG. 1(b), a nonadiabatic tapered single material HF structure with gradually collapsed air holes is provided. For the fabrication of the structure a HF is used, which consist of a pure silica core surrounded by pure silica cladding with a regular array of air holes that run inside the cladding along the length of the fiber. The holes are also arranged in a hexagonal structure around the core. For example, a large-core, single-mode HF, see FIG. 1(a), with a few rings of air-holes in the cladding that is described in more detail in [12] can be used. The claimed nonadiabatic tapered single material HF structure [see FIG. 1(b)] consists of two untapered holey fibers at z<−Z_{L} and z>Z_{L}, two gradually tapered regions −Z_{L} to −Z_{W} and Z_{W} to Z_{L}, and a cylindrical waist region −Z_{W} to Z_{W}. In the region −Z_{C} to Z_{C}, the air holes are fully collapsed. In the regions −Z_{L} to −Z_{C} and Z_{L} to Z_{C}, gradual collapsing of air holes occurs. The transmission spectrum of the taper exhibits a series of peaks. The number of the peaks increases as the diameter of the taper waist is reduced or the length of the taper is increased. Also the peaks become sharper for the same reasons. Such interference peaks are sensitive to the external environment and that allows using our invention as a sensor for measuring many parameters.

According to the second aspect of the invention a manufacturing process for nonadiabatic tapered single material HF structure with collapsed air holes is provided. The gradual collapsing of the holes is achieved by tapering the fibers with a “slow-and-hot” method. This nonadiabatic process makes the fundamental mode of the holey fiber to couple into multiple modes of the solid taper waist. Owing to the beating between the multiple modes the transmission spectra of the tapered holey fibers exhibit several interference peaks. By such a way, all-fiber Mach-Zehnder type interferometer is formed in a holey fiber [13].

With these aspects of the invention it is possible to use it as a sensor for high-accuracy refractometric measurements [14], temperature-independent (up to 180° C.) strain measurements [15], and measurements of high temperatures (up to 1000° C.) [16]. It can be also used for the measurements of many others parameters [17, 18].

### BRIEF DESCRIPTION OF THE INVENTION DRAWING

FIG. 1(a) shows a cross section of the cleaved end of an untapered single material HF, (b) is an illustration of a uniform-waist taper, fabricated with nonadiabatic process, embodying the first aspect of the invention. The outer diameter of this HF is 125 μm and the relative hole diameter d/Λ=0.5. The variables that appear in the figure are discussed in the text.

FIG. 2 shows atomic force microscope (AFM) images of three gradually tapered with nonadiabatic process single material HFs with uniform waist diameters of 50 μm (a), 39 μm (b), and 31 μm (c). The scan sizes of AFM images are, respectively, 13.3, 11.9, and 3.8 μm.

FIG. 3 shows the normalized transmission spectra of three tapered with nonadiabatic process single material HFs with waist diameters ρ_{w} of 28 μm (a), 20 μm (b), and 15 μm (c). L=3 mm in all cases.

FIG. 4 illustrates the normalized transmission spectra (left) and position of the maxima of the peak or peaks (right) as a function of the external refractive index of three, tapered with nonadiabatic process, single material HFs with the waist diameters of 39 (top plots), 31 (middle plots) and 20 μm (bottom plots). L=5 mm for all cases. The peaks are numbered to show the shift to longer wavelengths they suffered when the external index changes.

FIG. 5 illustrates the normalized transmission spectra of three tapered with nonadiabatic process single material HFs with waist diameters ρ_{w} of 28 μm (a), 20 μm (b), and 15 μm (c). L=10 mm in all cases.

FIG. 6 illustrates the normalized transmission spectra for a single material HF taper with ρ_{w}=25 μm fabricated with nonadiabatic tapering process. The spectra were obtained at different wavelengths.

FIG. 7 shows the normalized transmission spectra of the single material HF before (dotted line) and after (continuous line) nonadiabatic tapering. The taper waist diameter is 28 μm and L=5 mm.

FIG. 8 shows the normalized transmission spectra of a tapered with nonadiabatic process single material HF with the waist diameter of 28 μm and L=5 mm under strain 0 με (black lane), 1100 με (red line), and 2200 με (blue line) measured by using two LED with central wavelengths 1540 nm (a) and 1290 nm (b), respectively.

FIG. 9 presents a typical shift of the peaks in FIG. 8 (peaks near wavelengths 1520 nm and 1250 nm) as a function of the applied strain.

### DETAILED DESCRIPTION OF THE INVENTION

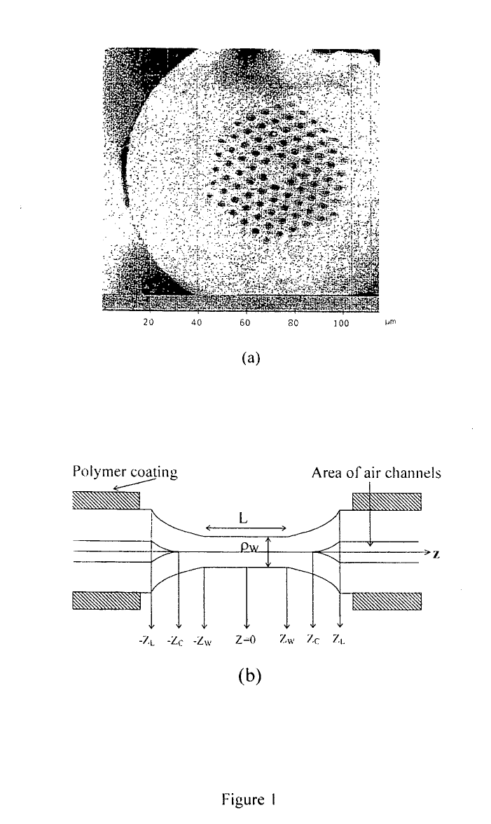

FIG. 1 shows a cross section of the cleaved end of a single material HF, as well as schematic representation of the taper fabricated with nonadiabatic process embodying the first aspect of the invention. The fiber employed to fabricate the tapers may be a large-mode-area single-mode, made from single material HF with a solid core surrounded by hexagonal rings air holes in the cladding. The fabrication and properties of one type of such single material HFs are described in detail in [12], for example. The claimed nonadiabatic tapered single material HF structure [see FIG. 1(b)] consists of two untapered holey fibers at z<−Z_{L} and z>Z_{L}, two gradually tapered regions −Z_{L} to −Z_{W} and Z_{W} to Z_{L}, and a cylindrical region −Z_{W} to Z_{W}, or waist. In the region from −Z_{C} to Z_{C} the air holes are fully collapsed. In the regions from −Z_{L} to −Z_{C} and from Z_{L} to Z_{C} gradual collapsing of the air holes occurred. As one can see from FIG. 1(a) the cladding of the untapered HF consists of several rings of air holes arranged in hexagonal pattern. It is possible to use the single material HF with 125 μm outside diameter (the outer diameter of a typical communications fiber), with a solid core of 11 μm in diameter, with average hole diameter d of 2.7 μm, and with an average hole spacing, or pitch, Λ, of 5.45 μm. A variety of suitable microstructures of the HF cladding is possible and is known in the art. Air holes, of a variety of shapes and configurations, are generally useful.

According to the second aspect of the invention a manufacturing process for a nonadiabatic tapered single material HF structure with gradually collapsed air holes is provided. To obtain the structure it is possible to insert the HF into a standard single-mode fiber by fusion splicing both fibers. This allows one to use short length of the HF (about 30 cm). Then the HF is placed into an apparatus, in which a section of the fiber is heated at a high temperature and then it is slowly stretched. Under these conditions a nonadiabatic tapered single material HF structure is obtained and in the (−Z_{C}+Z_{C}) region the air holes are fully collapsed. For example, the outside diameter of the cylindrical waist region of the taper is reduced four times in comparison to the initial outside diameter of the HF. A variety of tapering machines are known in the art. An oscillating high-temperature flame torch is preferable because it can provide the needed short and hot zone of heating.

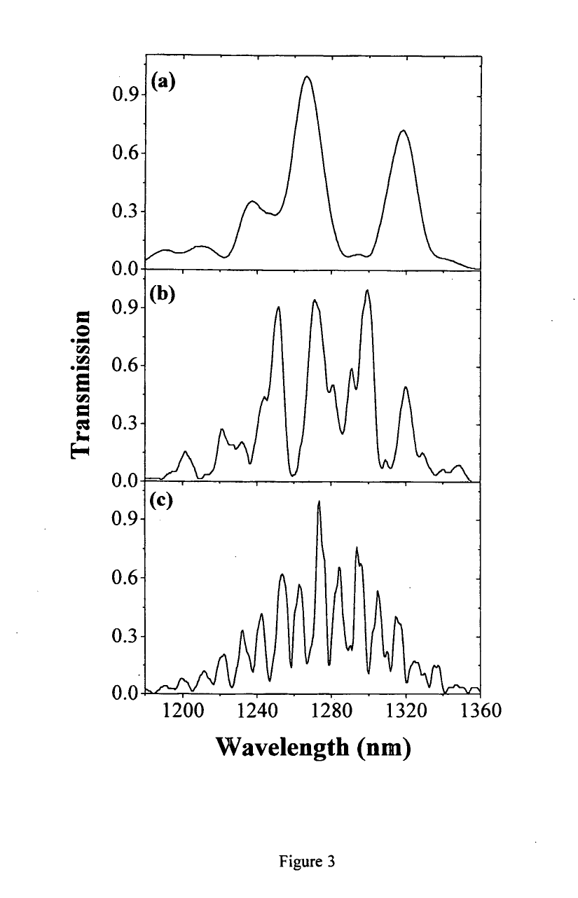

With these aspects of the invention the transmission spectra of such tapers exhibit multiple interference peaks (see FIG. 3, for example). In the inventors' reference [18] it was provided a detail theoretical investigation of the transmission properties of the nonadiabatic tapered large core single-mode, made from single material HF with gradually collapsed air holes in according to the invention. It was shown that the multiple interference peaks at the taper output appeared owing to interference between several modes in the taper waist. Such interference peaks are sensitive to the external environment since the propagation constants of the modes depend on it. The nonadiabatic tapered single material HF behaves like a modal Mach-Zehnder interferometer [13] since the interference between the multiple modes occurs owing to the different optical paths traveled by the modes along the taper. The multiple peaks, combined with a fitting algorithm, allow high-accuracy temperature-independent refractometric measurements [14], temperature-independent strain measurements [15], as well as measurements of high temperature [16]. They can also be used for the measurement of many others physical or chemical parameters [17,18].

### EXAMPLE 1

The fiber employed to fabricate the tapers was a large core single-mode, made from single material, HF with a solid silica core surrounded by a few air holes in the cladding. The fabrication and properties of such a fiber are described in detail in [12]. As one can see from FIG. 1(a) the untapered single material HF consists of four full rings of air holes in hexagonal pattern (the fifth ring is partially collapsed). The outer diameter of the HF is 125 μm, the diameter of the solid core is 11 μm, the average hole diameter d is 2.7 μm, and the average hole spacing, or pitch, Λ is 5.45 μm. To obtain a nonadiabatic tapered single material HF structure we first inserted the HF into a standard single-mode fiber by fusion splicing both fibers. This allowed us to seal the ends of the HF. The length of the HF was chosen to be about 30 cm. Then the HF is slowly stretched while it was being heated with an oscillating high-temperature flame torch. The temperature of the flame was approximately 1000° C. The length of oscillation of the torch, and also the length of the uniform waist (−Z_{W}+Z_{W}) of the taper, [see FIG. 1(b)], was set to 5 mm. The pulling mechanism involves two sliding stands individually driven by stepper motors. The speed of each stand was approximately 2.0 mm/min. Several single material samples were fabricated with waist diameters between 20 to 50 μm under similar conditions. After the tapering process the tapers were cleaved under tension. Later they were examined using a commercial atomic force microscope (AFM) operated in contact mode.

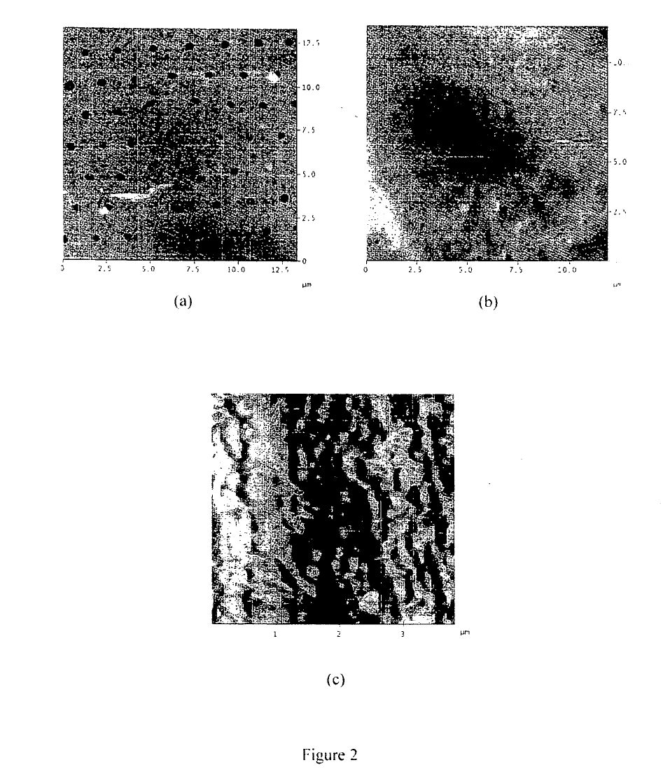

In FIGS. 2(a), (b), and (c) we show, respectively, AFM images of tapers with waist diameters of 50, 39, and 31 μm. It can be seen in the photographs that in the 50 and 39 μm-thick tapers the air holes are still present. It is worth noting that the single material holey structure in both tapers is also preserved. In the 31 μm-thick taper, however, the holes are totally collapsed and the holey structure cannot be distinguished. In this case, part of the tapered section of the single material HF becomes a solid silica fiber (with infinite cladding) which can support multiple modes. However, not all the modes are necessary excited. The beating between the multiple modes of the solid section of the taper give rise to multiple interference peaks.

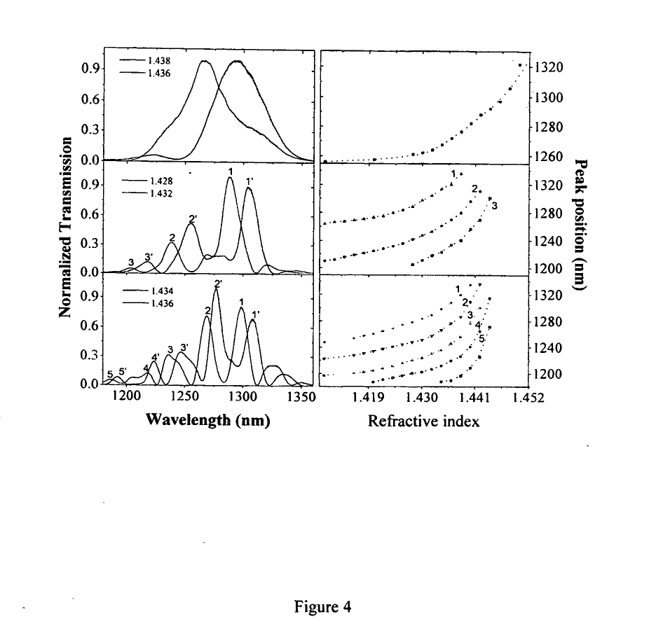

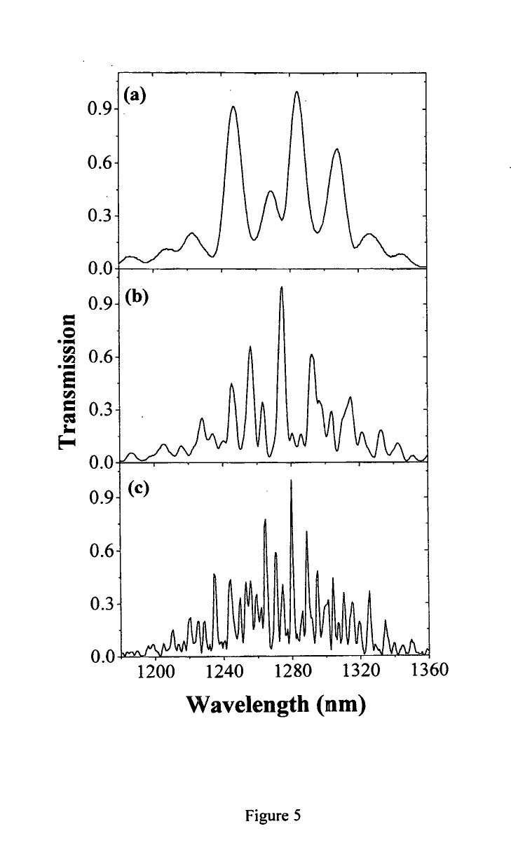

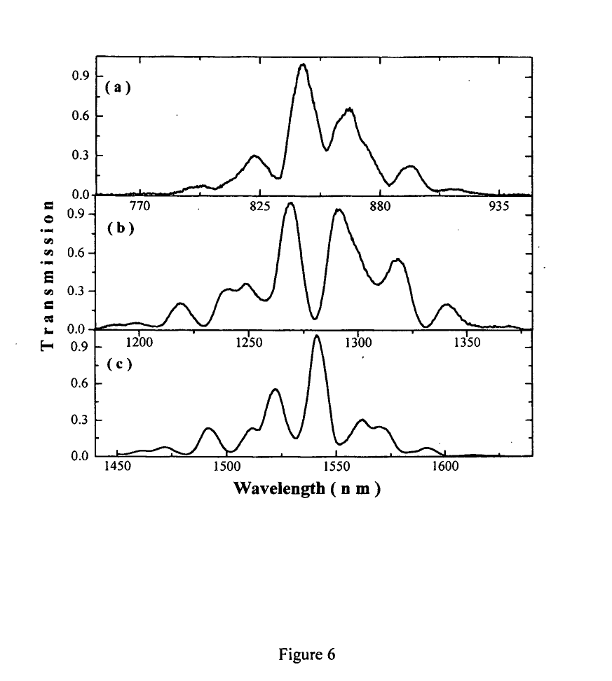

To analyze the transmission spectra of the tapers a simple light transmission measurement setup consisting of a low power light emitting diode (LED), with peak emission at 1290 nm and 80 nm of spectral width, and a high-resolution optical spectrum analyzer was implemented. The measured transmission spectra of three tapered single material HFs in air are shown in FIG. 4, left plots (black curves). The waist diameters ρ_{w} of the tapered fibers, from top to bottom of FIG. 4, are, respectively, 39, 31, and 20 μm. The three spectra were normalized with respect to the maxima of the highest peaks. It can be noted from the figure that the spectrum of the 39 μm-thick taper, in which air holes are not collapsed, see FIG. 2(b), is basically the output spectrum of the LED. However, the spectra of the tapers with waist diameter of 31 and 20 μm, in which air holes are gradually collapsed, exhibit a series of peaks. The number of peaks increases as the diameter of the taper is reduced. Note also that the peaks become sharper as the taper becomes thinner. It is also necessary to note that the number of the interference peaks is also increased and they also become sharper as the length of the taper waist L is increased, compare FIG. 3 and FIG. 5. These figures show the normalized transmission spectra of three tapered with nonadiabatic process single material HFs with waist diameters ρ_{w} of 28 μm (a), 20 μm (b), and 15 μm (c) but with different length of the taper waist L (3 mm and 10 mm, respectively). FIG. 6 shows that at measuring of the transmission spectra of the claimed tapers it is possible to use LEDs with different wavelengths. FIG. 4 also shows the transmission spectra and the position of the maxima of the peaks as a function of the external refractive index for three tapered single material HFs with the waist diameters of 39, 31, and 20 μm. One can see from this figure that all interference peaks shift to longer wavelengths as the external index augments. The shift of the peaks is more remarkable for indexes higher than 1.440. In that range of indexes the estimated maximum resolution of the sensor was found to be around 1×10⁻⁵, considering that the resolution of the used spectrum analyzer was 2 nm. Note also from the figure that the intensity of the peaks changes with the index, but their shape remains constant.

The experiments revealed that the interference peaks always appeared for tapers with diameters thinner than 31 μm. However, the position of the maxima of such peaks varied slightly. One interesting feature of nonadiabatical tapering a single material HF with a “slow-and-hot” method is that the interference peaks can be monitored during the tapering process. Thus, one may stop the process when the desirable numbers of peaks are obtained. It was observed that the interference peaks were insensitive to temperature (in the range 0-180° C.). This property is important since temperature compensation,—a familiar problem in optical sensors,—is not necessary for sensors based on tapered HFs with gradually collapsed air holes. Another interesting feature of the tapers is the multiple interference peaks themselves. All such peaks can be used simultaneously to monitor the refractive index of the medium surrounding the taper. It is not difficult to show [14] that the use four peaks instead of one may improve the accuracy of the measurements by factor of two.

### EXAMPLE 2

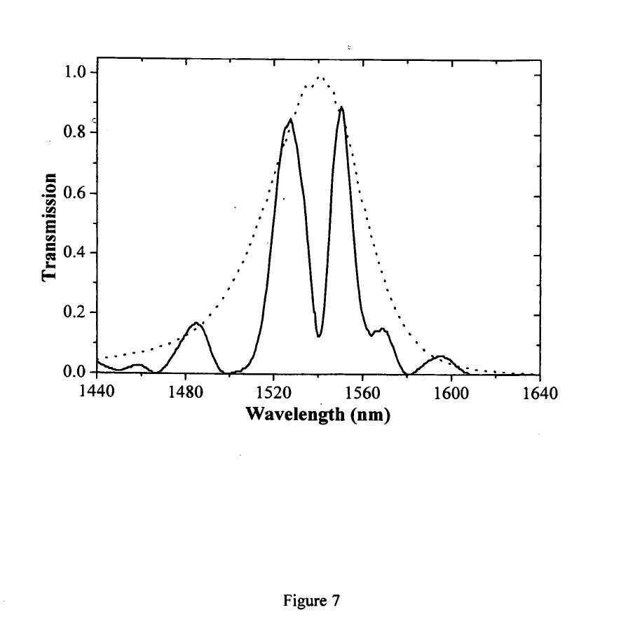

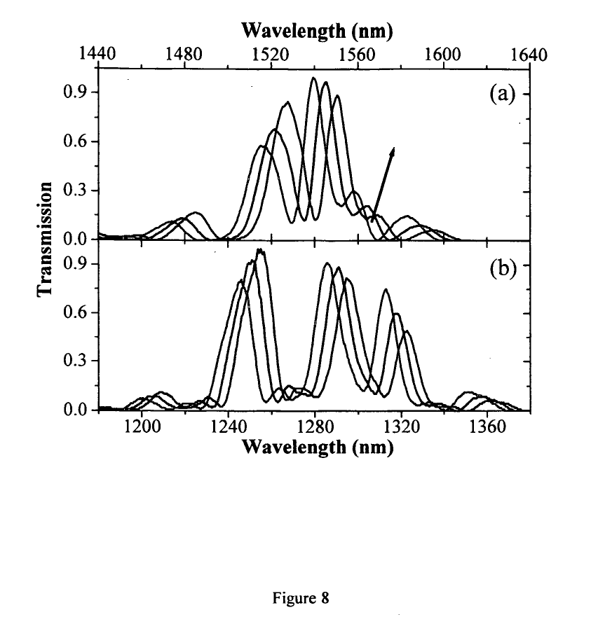

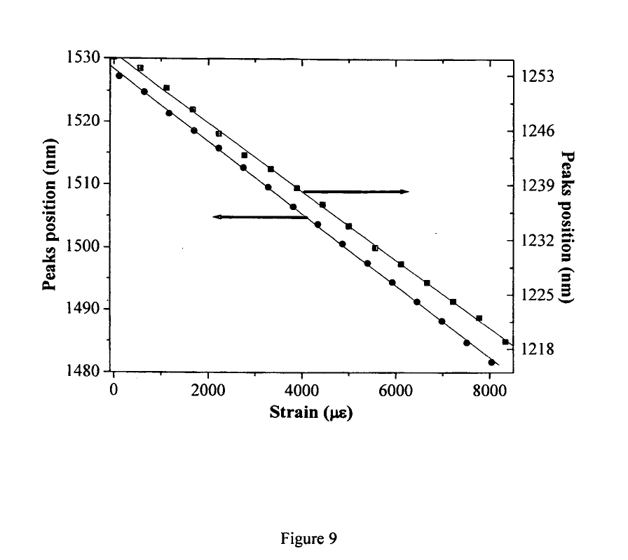

By using the same fiber, and the same tapering process as in example 1, a single material HF taper with waist diameter ρ_{w}=28 μm and L=5 mm was fabricated. FIG. 7 shows the normalized transmission spectra of the HF before (dotted line) and after (continuous line) the nonadiabatic tapering process. The measurements were carried in a measuring setup consisting of a LED, with peak emission at 1540 nm and 40 nm of spectral with, and an optical spectrum analyzer with resolution of 0.1 nm. It is possible to see from the figure that the transmission of the untapered single material HF is basically the output spectrum of the LED. However, the spectrum of the 28 μm-thick taper exhibits a series of peaks, two of which are higher than the others. For this taper it was investigated the shift of the interference peaks caused by longitudinal strain. The HF was fixed between two displacement mechanical mounts, with the tapered section in the middle. Then the fiber was stretched using the calibrated micrometer screws of the mounts. FIG. 8(a) shows the normalized spectra, measured at 1540 nm, of the taper when subjected to 0, 1100, and 2200 με. It is possible to see the shift of the spectra to shorter wavelengths (from black to blue) when the strain is increased. When the strain was removed to the sensor all the peaks returned to their baseline. At this point, the LED was changed by another with peak emission at 1290 nm and repeated the experiments. The results are shown in FIG. 8(b). From this figure one can see that the transmission spectrum of the device also exhibits interference peaks around 1290 nm, and that such peaks also shift to shorter wavelength as the taper is elongated. Note that the height of some peaks increases and that others decreases. All peaks, however, maintain almost the same shape. The influence of temperature on the peaks was also investigated. The taper subjected to 0 με was exposed to different temperatures between 0 and 180° C. In that range of temperatures the interference peaks did not suffer any shift, but at higher temperatures, the peaks shifted to longer wavelength. Hence, a nonadiabatically tapered single material holey fiber with gradually collapsed air holes can be used for temperature-independent strain sensing [15]. The advantage of the sensor is that one can monitor one or all the peaks. In addition, different wavelengths can be used to interrogate the sensor. FIG. 9 shows the shift as a function of the applied strain of the interference peaks centered around 1520 and 1250 nm of FIGS. 8(a) and 8(b), respectively. The observed shift of both peaks has a linear behavior and the slope of both lines is basically the same. The observed shift of the other peaks shown in FIG. 8 had also a linear behavior with similar slope to the ones of the plots of FIG. 9. The experiments were carried out several times, observing in all cases that the sensor was reversible in the 0-8000 με range. Prior art fiber-based strain sensor devices suffer a cross-sensitivity to temperature. Thus, the sensor on a basis of the proposed HF taper exhibits a linear response, it is temperature independent (in the range 0-180° C.), reversible, and can operate at different wavelength. It can be incorporated into civil and spacecraft structures, smart materials, active devices and components, etc. to monitor the strain-induced changes suffered by such structures, materials or components.

### REFERENCES

1. P. St. J. Russell, “Photonic crystal fibers,” Science, 299, 358-362 (2003).

2. A. Bjarklev, J. Broeng, and A. S. Bjarklev, Photonic Crystal Fibres (Kluver Academic Publishers, Boston, 2003).

3. T. M. Monro, W. Belardi, K. Furusawa, J. C. Bagget, N. G. R. Broderick, and D. J. Richardson, “Sensing with microstructured optical fibers,” Meas. Sci. Technol., 12, 854-858 (2001).

4. J. M. Fini, “Microstructure fibres for optical sensing in gases and liquids,” Meas. Sci. Technol., 15, 1120-1128 (2004).

5. S. O. Konorov, A. Zheltikov, and M. Scalora, “Photonic-crystal fiber as a multifunctional optical sensor and sample collector,” Opt. Express, 13, 3454-3459 (2005).

6. J. B. Jensen, P. E. Holby, G. Emiliyanov, O. Bang, L. H. Pedersen, and A. Bjarklev, “Selective detection of antibodies in microstructured polymer optical fibers,” Opt. Express, 13, 5883-5889 (2005).

7. T. M. Monro, D. J. Richardson, and P. J. Bennet, “Developing holey fibers for evanescent field devices,” Electron. Lett., 35, 1188-1189 (1999).

8. N. G. R. Broderick, P. J. Bennett, T. M. Monro, and D. J. Richardson, Holey optical fibers, U.S. Pat. No. 6,577,801, United States of America, Jun. 2003.

9. Y. K. Lize, E. C. Magi, V. G. Ta'eed, J. A. Bolger, P. Steinvurzel, and B. J. Eggleton, “Microstructured optical fiber photonic wires with subwavelength core diameter,” Opt. Express, 12, 3209-3217 (2004).

10. E. C. Magi, H. C. Nguyen, and B. J. Eggleton, “Air-hole collapse and mode transitions in microstructured fiber photonic wires,” Opt. Express, 13, 453-459 (2005).

11. J. Chandalia, D. J. DiGiovanni, B. J. Eggleton, S. G. Kosinski, R. S. Windeler, Process for fabricating tapered microstructured fiber system and resultant system, U.S. Pat. No. 6,654,522, United States of America, Nov. 2003.

12. V. P. Minkovich, A. V. Kir'yanov, A. B. Sotsky, and L. I. Sotskaya, “Large-mode-area holey fibers with a few air channels in cladding: modeling and experimental investigation of modal properties,” J. Opt. Soc. Am. B, 21, 1161-1169 (2004).

13. J. Villatoro, V. P. Minkovich, and D. Monzón-Hernández, “Compact modal interferometer built with tapered microstructured optical fiber”, IEEE Photon. Technol. Lett., 18, 1258-1260, (2006).

14. V. P. Minkovich, J. Villatoro, D. Monzón-Hernández, S. Calixto, A. B. Sotsky, and L. I. Sotskaya, “Holey fiber tapers with resonanse transmisión for high-resolution refractive index sensing,” Opt. Express, 13, 7609-7614 (2005).

15. J. Villatoro, V. P. Minkovich, and D. Monzón-Hernández, “Temperature-independent strain sensor made of tapered holey optical fiber,” Opt. Lett., 31, 305-307(2005).

16. D. Monzón-Hernández, V. P. Minkovich, and J. Villatoro, “High-temperature sensing with tapers made of microstructured optical fibers,” IEEE Photon. Technol. Lett., 18, 511-513 (2006).

17. V. P. Minkovich, D. Monzón-Hernández, J. Villatoro, and Goncal Badenas, “Microstructured optical fiber coated with thin films for gas and chemical sensing”, Opt. Express, 14, 8413-8414 (2006).

18. V. P. Minkovich, D. Monzón-Hernández, J. Villatoro, A. B. Sotsky, and L. I. Sotskaya, “Modeling of holey fiber tapers with selective transmission for sensor applications,” J. Lightw. Technol., 24, 4319-4328 (2006).

What is claimed is:

1. A single material holey fiber tapered structure comprising two untapered holey fiber and one nonadiabadically tapered region at the input and one at the output of the structure, respectively, and one cylindrical waist region.

2. A single material holey fiber tapered structure according to claim 1, wherein an untapered single material holey fiber is a single-mode fiber that consists of a solid core and a cladding that contains air channels (air holes) that run lengthwise down the optical fiber and that are distributed across the optical fiber adjacent to the core.

3. A single material holey fiber tapered structure according to claims 1 and 2, wherein the core material, the cladding material and the cylindrical waist region material may be formed from a variety of suitable materials, including glasses and polymers.

4. A single material holey fiber tapered structure according to claim 1, wherein the air channels are arranged in a substantially hexagonal pattern.

5. A single material holey fiber tapered structure according to claim 1, wherein the air channels are fully collapsed in the cylindrical waist region.

6. A single material holey fiber tapered structure according to claim 1, wherein inside two tapered regions gradual collapsing of air channels occurs.

7. A single material holey fiber tapered structure according to claim 6, wherein the fundamental mode of the HF transforms into multiple modes of the solid taper waist.

8. A single material holey fiber tapered structure according to claim 6, wherein several multiple modes of the solid taper waist have interfered giving multiple interference peaks at the output of the structure.

9. A single material holey fiber tapered structure according to claim 8, wherein the several multiple modes of the solid taper waist and respectively the interference peaks at the output of the structure are sensitive to the external environment.

10. A single material holey fiber tapered structure according to claim 8, where the number of the interference peaks at the output of the structure is increased as the diameter of the solid taper waist is reduced.

11. A single material holey fiber tapered structure according to claim 8, where the peaks become sharper as the diameter of the solid taper waist is reduced.

12. A single material holey fiber tapered structure according to claim 8, where the number of the interference peaks at the output the structure is increased as the length of the taper waist is increased.

13. A single material holey fiber tapered structure according to claim 8, where the peaks become sharper as the length of the taper waist is increased.

14. A single material holey fiber tapered structure according to claim 8, where the interference peaks appears in a wide wavelength range.

15. A process for forming an article, comprising the steps of:
providing a single-mode and a single material holey fiber comprising a solid core and a cladding that contains air channels (air holes) that run lengthwise down the optical fiber and that are distributed across the optical fiber adjacent to the core; and
treating a portion of the HF by heating it at high temperature and slowly stretching, wherein the treatment is performed such that the single material holey fiber structure is gradually modified along the propagation direction.

16. The process of claim 15, wherein the stretching provides two untapered
single material holey fibers, two gradually tapered regions, and a cylindrical waist region between tapered regions.

17. The process of claim 15, wherein the treating step fully collapses the holes in the waist region.

18. The process of claim 15, wherein gradually tapered regions are nonadiabatically tapered, such that a fundamental mode propagating through the unstretched single material holey fiber transforms into multiple modes of the solid taper waist region.

19. The process of claim 18, wherein several multiple modes of the solid taper waist have interfered giving multiple interference peaks at the output of the structure.
